(19) United States
(12) Patent Application Publication
(10) Pub. No.: US 2010/0281236 A1
(43) Pub. Date: Nov. 4, 2010

(54) APPARATUS AND METHOD FOR TRANSFERRING DATA WITHIN A VECTOR PROCESSOR

(75) Inventors: Shlomo Selim Rakib, Cupertino, CA (US); Muhammad Ahmed, Hayward, CA (US); Marc Schaub, Sunnyvale, CA (US)

Correspondence Address: Stevens Law Group, 1754 Technology Drive, Suite #226, San Jose, CA, 95110, US

(73) Assignee: Novafora, Inc., San Jose, CA (US)

(21) Appl. No.: 12/433,821

(22) Filed: Apr. 30, 2009

(51) Int. Cl. G06F 9/30; G06F 15/80; G06F 9/06

(52) U.S. Cl. 712/17; 712/225; 712/228; 712/E09.016; 712/E09.003

(57) ABSTRACT

An apparatus for processing data may include an array of processing elements (such as an n×m or n×n array of processing elements) configured to simultaneously perform operations on a plurality of data elements using a single instruction. Each processing element in the array may be configured to transfer data directly to at least one neighboring processing element within the array. In selected embodiments, the apparatus may include exchange registers to temporarily store data transferred between neighboring processing elements.

### BACKGROUND

This invention relates to data processing, and more particularly to apparatus and methods for transferring data between processing elements in a vector processor.

Signal and media processing (also referred to herein as “data processing”) is pervasive in today's electronic devices. This is true for cell phones, media players, personal digital assistants, gaming devices, personal computers, home gateway devices, and a host of other devices. From video, image, or audio processing, to telecommunications processing, many of these devices must perform several if not all of these tasks, often at the same time.

For example, a typical “smart” cell phone may require functionality to demodulate, decrypt, and decode incoming telecommunications signals, and encode, encrypt, and modulate outgoing telecommunication signals. If the smart phone also functions as an audio/video player, the smart phone may require functionality to decode and process the audio/video data. Similarly, if the smart phone includes a camera, the device may require functionality to process and store the resulting image data. Other functionality may be required for gaming, wired or wireless network connectivity, general-purpose computing, and the like. The device may be required to perform many if not all of these tasks simultaneously.

Similarly, a “home gateway” device may provide basic services such as broadband connectivity, Internet connection sharing, and/or firewall security. The home gateway may also perform bridging/routing and protocol and address translation between external broadband networks and internal home networks. The home gateway may also provide functionality for applications such as voice and/or video over IP, audio/video streaming, audio/video recording, online gaming, wired or wireless network connectivity, home automation, VPN connectivity, security surveillance, or the like. In certain cases, home gateway devices may enable consumers to remotely access their home networks and control various devices over the Internet.

Depending on the device, many of the tasks it performs may be processing-intensive and require some specialized hardware or software. In some cases, devices may utilize a host of different components to provide some or all of these functions. For example, a device may utilize certain chips or components to perform modulation and demodulation, while utilizing other chips or components to perform video encoding and processing. Other chips or components may be required to process images generated by a camera. This may require wiring together and integrating a significant amount of hardware and software.

Currently, there is no unified architecture or platform that can efficiently perform many or all of these functions, or at least be programmed to perform many or all of these functions. Thus, what is needed is a unified platform or architecture that can efficiently perform tasks such as data modulation, demodulation, encryption, decryption, encoding, decoding, transcoding, processing, analysis, or the like, for applications such as video, audio, telecommunications, and the like. Further needed is a unified platform or architecture that can be easily programmed to perform any or all of these tasks, possibly simultaneously. Such a platform or architecture would be highly useful in home gateways or other integrated devices, such as mobile phones, PDAs, video/audio players, gaming devices, or the like.

### BRIEF DESCRIPTION OF THE DRAWINGS

In order that the advantages of the invention will be readily understood, a more particular description of the invention briefly described above will be rendered by reference to specific examples illustrated in the appended drawings. Understanding that these drawings depict only typical examples of the invention and are not therefore to be considered limiting of its scope, the invention will be described and explained with additional specificity and detail through use of the accompanying drawings, in which:

FIG. 1 is a high-level block diagram of one embodiment of a data processing architecture in accordance with the invention;

FIG. 2 is a high-level block diagram showing one embodiment of a group in the data processing architecture;

FIG. 3 is a high-level block diagram showing one embodiment of a cluster containing an array of processing elements (i.e., a VPU array);

FIG. 4 is a high-level block diagram of one embodiment of an array of processing elements, the processing elements configured to transfer data to neighboring processing elements;

FIG. 5 is a high-level block diagram showing one method for transferring data between processing elements;

FIG. 6 is a high-level block diagram showing various registers and flags in the processing element;

FIG. 7 is a high-level block diagram showing one embodiment of an instruction pipeline for the VPU array;

FIG. 8 is a high-level block diagram showing one embodiment of an instruction pipeline for the scalar ALU;

FIG. 9 is a high-level block diagram showing the combined pipelines for the VPU array and the scalar ALU; and

FIG. 10 is a high-level block diagram showing one embodiment of a vector processor controller (VPC) containing a grouping module and a modification module.

### DETAILED DESCRIPTION

The present invention provides an apparatus and method for transferring data between processing elements that overcome various shortcomings of the prior art. The features and advantages of the present invention will become more fully apparent from the following description and appended claims, or may be learned by practice of the invention as set forth hereinafter.

In a first embodiment, an apparatus in accordance with the invention includes an array of processing elements (such as an n×m or n×n array of processing elements) configured to perform operations on a plurality of data elements using a single instruction. The array of processing elements includes a first processing element and a second processing element adjacent to the first processing element. The first processing element is configured to transfer data directly to the second processing element. Similarly, in selected embodiments, the second processing element is configured to transfer data directly to the first processing element, thereby enabling bidirectional data transfer between the first and second processing elements.

In certain embodiments, the apparatus includes a first exchange register to temporarily store data transferred from the first processing element to the second processing element. The first processing element may communicate with a write port of the first exchange register and the second processing element may communicate with a read port of the first exchange register. Likewise, where the second processing element is configured to transfer data directly to the first processing element, the apparatus may include a second exchange register to temporarily store data transferred from the second processing element to the first processing element. This second processing element may communicate with a write port of the second exchange register and the first processing element may communicate with a read port of the second exchange register.

In another embodiment of the invention, a method for processing data may include providing an array of processing elements configured to simultaneously perform operations on a plurality of data elements using a single instruction. The array of processing elements includes a first processing element and a second processing element adjacent to the first processing element. The method may further include transferring, by the first processing element, data directly to the second processing element.

In yet another embodiment of the invention, an apparatus for processing data may include an array of processing elements (such as an n×m or n×n array of processing elements) configured to simultaneously perform operations on a plurality of data elements using a single instruction. Each processing element in the array may be configured to transfer data directly to at least one neighboring processing element within the array.

In selected embodiments, the apparatus may include exchange registers to temporarily store data transferred between neighboring processing elements. In certain embodiments, these exchange registers may enable unidirectional communication between neighboring processing elements. In other embodiments, the exchange registers may enable bidirectional communication between neighboring processing elements. Where the array of processing elements is an n×m or n×n array of processing elements, the processing elements may be configured to communicate with processing elements to the north, south, east, and west of the processing elements.

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

Many of the functional units described in this specification are shown as modules (or functional blocks) in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose of the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details may be provided, such as examples of programming, software modules, user selections, or the like, to provide a thorough understanding of embodiments of the invention. One skilled in the relevant art will recognize, however, that the invention can be practiced without one or more of the specific details, or with other methods or components. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

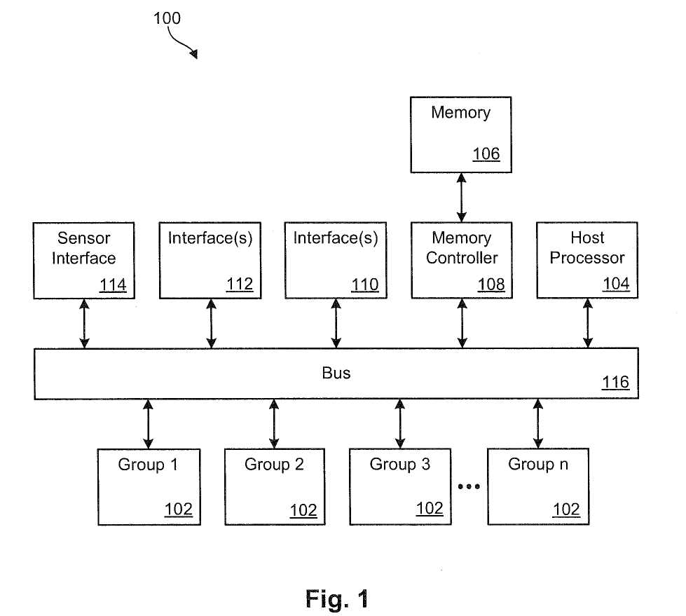

Referring to FIG. 1, one embodiment of a data processing architecture 100 in accordance with the invention is illustrated. The data processing architecture 100 may be used to process (i.e., encode, decode, transcode, analyze, process) audio or video data although it is not limited to processing audio or video data. The flexibility and configurability of the data processing architecture 100 may also allow it to be used for tasks such as data modulation, demodulation, encryption, decryption, or the like, to name just a few. In certain embodiments, the data processing architecture may perform several of the above-stated tasks simultaneously as part of a data processing pipeline.

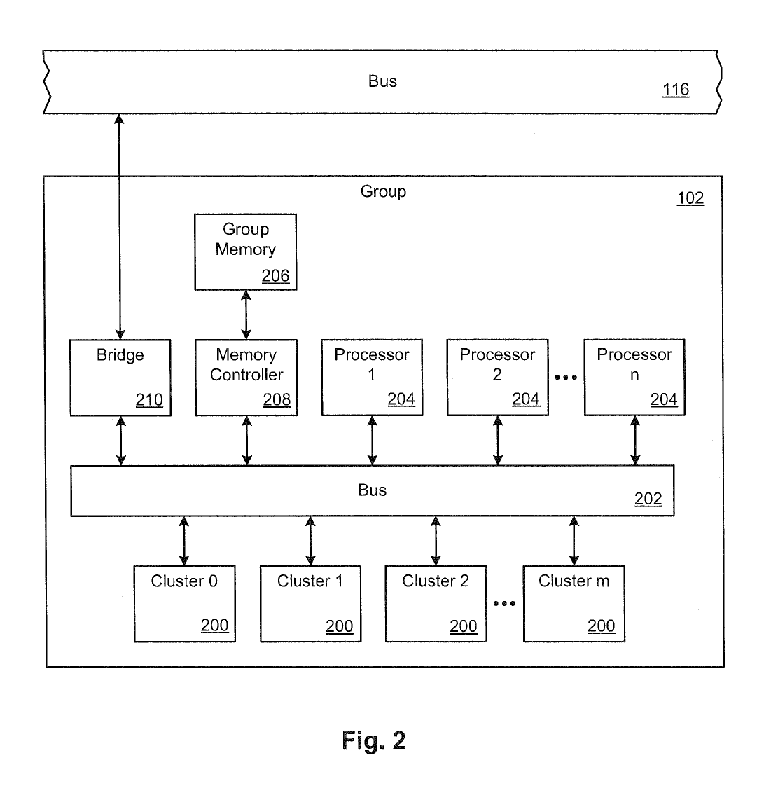

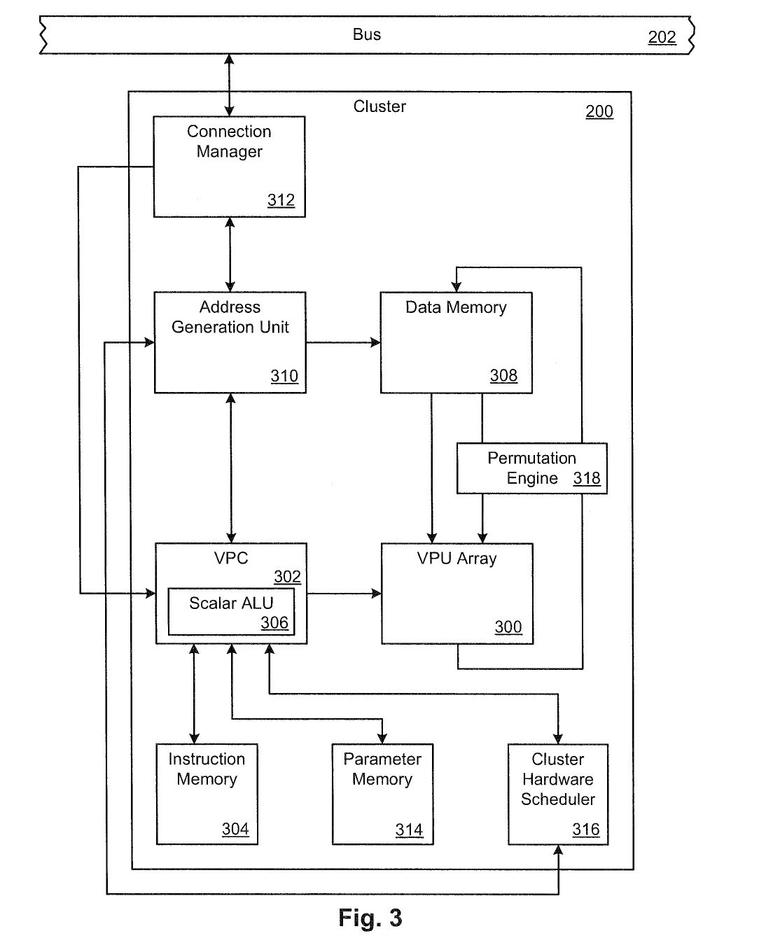

In certain embodiments, the data processing architecture 100 may include one or more groups 102, each containing one or more clusters of processing elements (as will be explained in association with FIGS. 2 and 3). By varying the number of groups 102 and/or the number of clusters within each group 102, the processing power of the data processing architecture 100 may be scaled up or down for different applications. For example, the processing power of the data processing architecture 100 may be considerably different for a home gateway device than it is for a mobile phone and may be scaled up or down accordingly.

The data processing architecture 100 may also be configured to perform certain tasks (e.g., demodulation, decryption, decoding) simultaneously. For example, certain groups and/or clusters within each group may be configured for demodulation while others may be configured for decryption or decoding. In other cases, different clusters may be configured to perform different steps of the same task, such as performing different steps in a pipeline for encoding or decoding video data. For example, where the data processing architecture 100 is used for video processing, one cluster may be used to perform motion compensation, while another cluster is used for deblocking, and so forth. How the process is partitioned across the clusters is a design choice that may differ for different applications. In any case, the data processing architecture 100 may provide a unified platform for performing various tasks or processes without the need for supporting hardware.

In certain embodiments, the data processing architecture 100 may include one or more processors 104, memory 106, memory controllers 108, interfaces 110, 112 (such as PCI interfaces 110 and/or USB interfaces 112), and sensor interfaces 114. A bus 116 or fabric 116, such as a crossbar switch 116, may be used to connect the components together. A crossbar switch 116 may be useful in that it provides a scalable interconnect that can mitigate possible throughput and contention issues.

In operation, data, such as video data, may be streamed through the interfaces 110, 112 into a data buffer memory 106. This data may, in turn, be streamed from the data buffer memory 106 to group memories 206 (as shown in FIG. 2) and then to cluster memories 308 (as shown in FIG. 3), each forming part of a memory hierarchy. Once in the cluster memories 308, the data may be operated on by arrays 300 of processing elements (i.e., VPU arrays 300). The groups and clusters will be described in more detail in FIGS. 2 and 3. In certain embodiments, a data pipeline may be created by streaming data from one cluster to another, with each cluster performing a different function (e.g., motion compensation, deblocking, etc.). After the data processing is complete, the data may be streamed back out of the cluster memories 308 to the group memories 206, and then from the group memories 206 to the data buffer memory 106 and out through the one or more interfaces 110, 112.

In selected embodiments, a host processor 104 (e.g., a MIPS processor 104) may control and manage the actions of each of the components 102, 108, 110, 112, 114 and act as a supervisor for the data processing architecture 100. The host processor 104 may also program each of the components 102, 108, 110, 112 with a particular application (video processing, audio processing, telecommunications processing, modem processing, etc.) before data processing begins.

In selected embodiments, a sensor interface 114 may interface with various sensors (e.g., IRDA sensors) which may receive commands from various control devices (e.g., remote controls). The host processor 104 may receive the commands from the sensor interface 114 and take appropriate action. For example, if the data processing architecture 100 is configured to decode television channels and the host processor 104 receives a command to begin decoding a particular television channel, the processor 104 may determine what the current loads of each of the groups 102 are and determine where to start a new process. For example, the host processor 104 may decide to distribute this new process over multiple groups 102, keep the process within a single group 102, or distribute it across all of the groups 102. In this way, the host processor 104 may perform load-balancing between the groups 102 and determine where particular processes are to be performed within the data processing architecture 100.

Referring to FIG. 2, one embodiment of a group 102 is illustrated. In general, a group 102 may be a semi-autonomous data processing unit that may include one or more clusters 200 of processing elements. The components of the group 102 may communicate over a bus 202 or fabric 202, such as a crossbar switch 202. The internal components of the clusters 102 will be explained in more detail in association with FIG. 3. In certain embodiments, a group 102 may include one or more management processors 204 (e.g., MIPS processors 204), group memories 206 and associated memory controllers 208. A bridge 210 may connect the group 102 to the primary bus 116 illustrated in FIG. 1. Among other duties, the management processors 204 may perform load balancing across the clusters 200 and dispatch tasks to individual clusters 200 based on their availability. Prior to dispatching a task, the management processors 204 may, if needed, send parameters to the clusters 200 in order to program them to perform particular tasks. For example, the management processors 204 may send parameters to program an address generation unit, a cluster scheduler, or other components within the clusters 200, as shown in FIG. 3.

Referring to FIG. 3, in selected embodiments, a cluster 200 in accordance with the invention may include an array 300 of processing elements (i.e., a vector processing unit (VPU) array 300). An instruction memory 304 may store instructions associated with threads running on the cluster 200 and intended for execution on the VPU array 300. A vector processor unit controller (VPC) 302 may fetch instructions from the instruction memory 304, decode the instructions, and transmit the decoded instructions to the VPU array 300 in a “modified SIMD” fashion. The VPC 302 may act in a “modified SIMD” fashion by grouping particular processing elements and applying an instruction modified to each group. This may allow different processing elements to handle the same instruction differently. For example, this mechanism may be used to cause half of the processing elements to perform an ADD instruction while the other half performs a SUB instruction, all in response to a single instruction from the instruction memory 304. This feature adds a significant amount of flexibility and functionality to the cluster 200.

The VPC 302 may have associated therewith a scalar ALU 306 which may perform scalar computations, perform control-related functions, and manage the operation of the VPU array 300. For example, the scalar ALU 306 may reconfigure the processing elements by modifying the groups that the processing elements belong to or designating how the processing elements should handle instructions based on the group they belong to.

The cluster 200 may also include a data memory 308 storing vectors having a defined number (e.g., sixteen) of elements. In certain embodiments, the number of elements in each vector may be equal to the number of processing elements in the VPU array 300, allowing each processing element within the array 300 to operate on a different vector element in parallel. Similarly, in selected embodiments, each vector element may include a defined number (e.g., sixteen) of bits. For example, where each vector includes sixteen elements and each element includes sixteen bits, each vector would include 256 bits. The number of bits in each element may be equal to the width (e.g., sixteen bits) of the data path between the data memory 308 and each processing element. It follows that if the data path between the data memory 308 and each processing element is 16-bits wide, the data ports (i.e., the read and write ports) to the data memory 308 may be 256-bits wide (16 bits for each of the 16 processing elements). These numbers are presented only by way of example are not intended to be limiting.

In selected embodiments, the cluster 200 may include an address generation unit 310 to generate real addresses when reading data from the data memory 308 or writing data back to the data memory 308. In selected embodiments, the address generation unit 310 may generate addresses in response to read/write requests from either the VPC 302 or connection manager 312 in a way that is transparent to the VPC 302 and connection manager 312. The cluster 200 may include a connection manager 312, communicating with the bus 202 or fabric 202, whose primary responsibility is to transfer data into and out of the cluster data memory 308 to/from the bus 202 or fabric 202.

In selected embodiments, instructions fetched from the instruction memory 304 may include a multiple-slot instruction (e.g., a three-slot instruction). For example, where a three-slot instruction is used, up to two (i.e., 0, 1, or 2) instructions may be sent to each processing element and up to one (i.e., 0 or 1) instruction may be sent to the scalar ALU 306. Instructions sent to the scalar ALU 306 may, for example, be used to change the grouping of processing elements, change how each group of processing elements should handle a particular instruction, or change the configuration of a permutation engine 318. In certain embodiments, the processing elements within the VPU array 300 may be considered parallel-semantic, variable-length VLIW (very long instruction word) processors, where the packet length is at least two instructions. Thus, in certain embodiments, the processing elements in the VPU array 300 may execute two or more instructions in parallel in a single clock cycle.

In certain embodiments, the cluster 200 may further include a parameter memory 314 to store parameters of various types. For example, the parameter memory 314 may store a processing element (PE) map to designate which group each processing element belongs to. The parameters may also include an instruction modifier designating how each group of processing elements should handle a particular instruction. In selected embodiments, the instruction modifier may designate how to modify at least one operand of the instruction, such as a source operand, destination operand, or the like. The PE map and instruction modifier may be loaded from the parameter memory 314 to the VPC 302 when starting a new thread.

In selected embodiments, the cluster 200 may be configured to execute multiple threads simultaneously in an interleaved fashion. In certain embodiments, the cluster 200 may have a certain number (e.g., two) of active threads and a certain number (e.g., two) of dormant threads resident on the cluster 200 at any given time. Once an active thread has finished executing, a cluster scheduler 316 may determine the next thread to execute. In selected embodiments, the cluster scheduler 316 may use a Petri net or other tree structure to determine the next thread to execute, and to ensure that any necessary conditions are satisfied prior to executing a new thread. In certain embodiments, the group processor 204 (shown in FIG. 2) or host processor 104 may program the cluster scheduler 316 with the appropriate Petri nets/tree structures prior to executing a program on the cluster 200.

Because a cluster 200 may execute and finish threads very rapidly, it is important that threads can be scheduled in an efficient manner. In certain embodiments, an interrupt may be generated each time a thread has finished executing so that a new thread may be initiated and executed. Where threads are relatively short, the interrupt rate may become so high that thread scheduling has the potential to undesirably reduce the processing efficiency of the cluster 200. Thus, apparatus and methods are needed to improve scheduling efficiency and ensure that scheduling does not create bottlenecks in the system. To address this concern, in selected embodiments, the cluster scheduler 316 may be implemented in hardware as opposed to software. This may significantly increase the speed of the cluster scheduler 316 and ensure that new threads are dispatched in an expeditious manner. Nevertheless, in certain cases, the cluster hardware scheduler 316 may be bypassed and scheduling may be managed by other components (e.g., the group processor 204).

In certain embodiments, the cluster 200 may include permutation engine 318 to realign data that it read from or written to the data memory 308. The permutation engine 318 may be programmable to allow data to a reshuffled in a desired order before or after it is processed by the VPU array 300. In certain embodiments, the programming for the permutation engine 318 may be stored in the parameter memory 314. The permutation engine 318 may permute data having a width (e.g., 256 bits) corresponding to the width of the data path between the data memory 308 and the VPU array 300. In certain embodiments, the permutation engine 318 may be configured to permute data with a desired level of granularity. For example, the permutation engine 318 may reshuffle data on an element-by-element basis or other desired level of granularity. Using this technique, the elements within a vector may be reshuffled as they are transmitted to or from the VPU array 300.

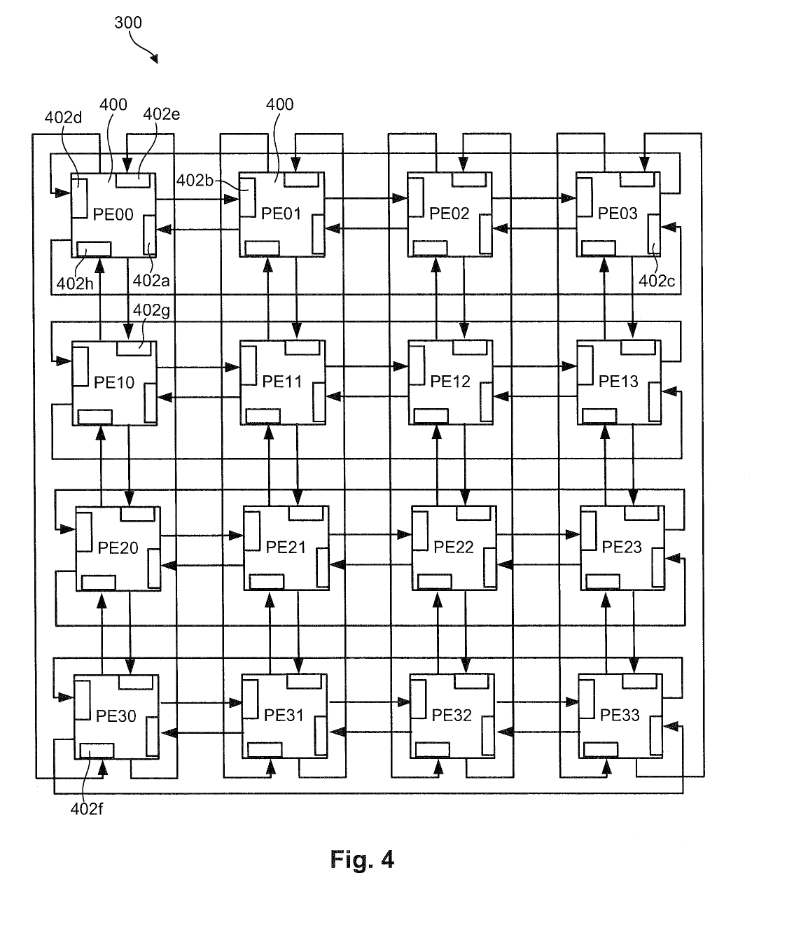

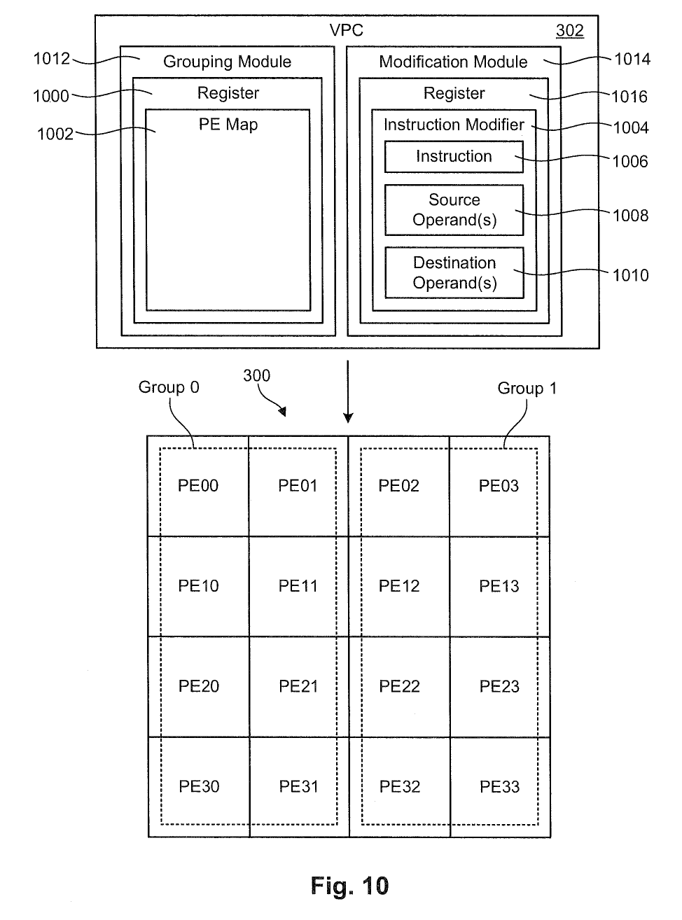

Referring to FIG. 4, as previously mentioned, the VPU array 300 may include an array of processing elements, such as an array of sixteen processing elements (hereinafter labeled PE00 through PE33). As previously mentioned, these processing elements may simultaneously execute the same instruction on multiple data elements (i.e., contained in a vector) in a “modified SIMD” fashion, as will be explained in more detail in association with FIG. 10. In the illustrated embodiment, the VPU array 300 includes sixteen processing elements arranged in a 4×4 array, with each processing element configured to process a sixteen bit data element. This arrangement of processing elements allows data to be passed between the processing elements in a specified manner as will be discussed. Nevertheless, the VPU array 300 is not limited to a 4×4 array. Indeed, the cluster 200 may be configured to function with other n×n or even n×m arrays of processing elements, with each processing element configured to process a data element of a desired size.

In selected embodiments, the processing elements may include one or more exchange registers 402a-h to transfer data between the processing elements. This may allow the processing elements to communicate with neighboring processing elements without the need to save the data to data memory 308 and then reload the data into internal registers 500. This may significantly increase the versatility of the VPU array 300 and increase the efficiency of the cluster 200 when performing various operations. For example, a first processing element 400 could perform a mathematic computation to produce a result. This result could be passed to an adjacent processing element 400 for use in a computation. All this can be done without the need to save and load the result from data memory 308.

For example, in selected embodiments, an exchange register 402a may have a read port that is coupled to PE00 and a write port that is coupled to PE01, allowing data to be transferred from PE01 to PE00. Similarly, an exchange register 402b may have a read port that is coupled to PE01 and a write port that is coupled to PE00, allowing data to be transferred from PE00 to PE01. This enables two-way communication between adjacent processing elements PE00 and PE01.

Similarly, for those processing elements on the edge of the array 300, the processing elements may be configured for “wrap-around” communication. For example, in selected embodiments, an exchange register 402c may have a write port that is coupled to PE00 and a read port that is coupled to PE03, allowing data to be transferred from PE00 to PE03. Similarly, an exchange register 402d may have a write port that is coupled to PE03 and a read port that is coupled to PE00, allowing data to be transferred from PE03 to PE00. Similarly, exchange registers 402e, 402f may enable two-way data transfer between processing elements PE00 and PE30 and exchange registers 402g, 402h may enable two-way data transfer between processing elements PE00 and PE10.

For the purposes of this description, “adjacent” or “neighboring” processing elements may include processing elements that communicate in a “wrap-around” manner. Similarly, in certain embodiments, “adjacent” or “neighboring” processing elements may include processing elements to the north, south, east, and/or west of other processing elements. In other embodiments, “adjacent” or “neighboring” processing elements may include processing elements that are located diagonally from other processing elements, such as processing elements to the northeast, northwest, southeast, or southwest of other processing elements.

In certain embodiments, the cluster 200 may be configured such that data may be loaded from the data memory 308 directly into the exchange registers 402 of the VPU array 300, and stored from the exchange registers 402 directly into the data memory 308. The cluster 200 may also be configured such that data may be loaded from the data memory 308 into internal registers and exchange registers 402 of the VPU array 300 simultaneously.

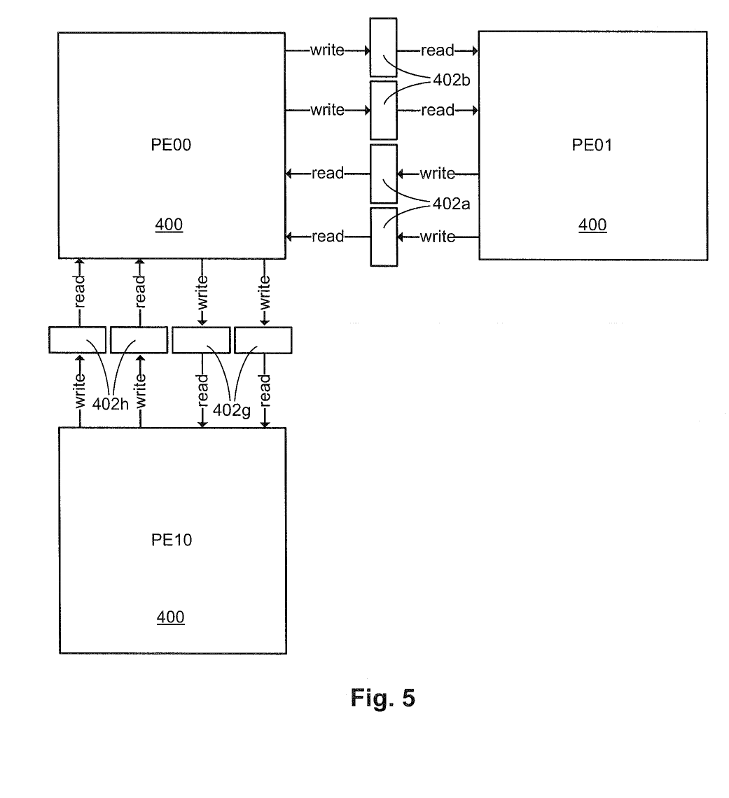

FIG. 5 is a more detailed view of several processing elements 400 and exchange registers 402 for transferring data between the processing elements. In this example, two pairs of exchange registers 402a, 402b are used to transfer data between PE00 and PE01. Another two pairs of exchange registers 402g, 402h are used to transfer data between PE00 and PE10. Thus, in selected embodiments, more than one exchange register 402 may be used to transfer data from one processing element 400 to another in any one direction. This may be helpful, for example, where a complex number is transferred between processing elements 400. In such a case, one of the exchange registers 402a may be used transfer the real part of the complex number and the other exchange register 402a may be used to transfer the imaginary part of the complex number to the adjacent processing element 400. Nevertheless, this is only an example and any number of exchange registers 402 may be provided between the processing elements 400. Similarly, the exchange registers 402 may be designed to hold data having any desired size.

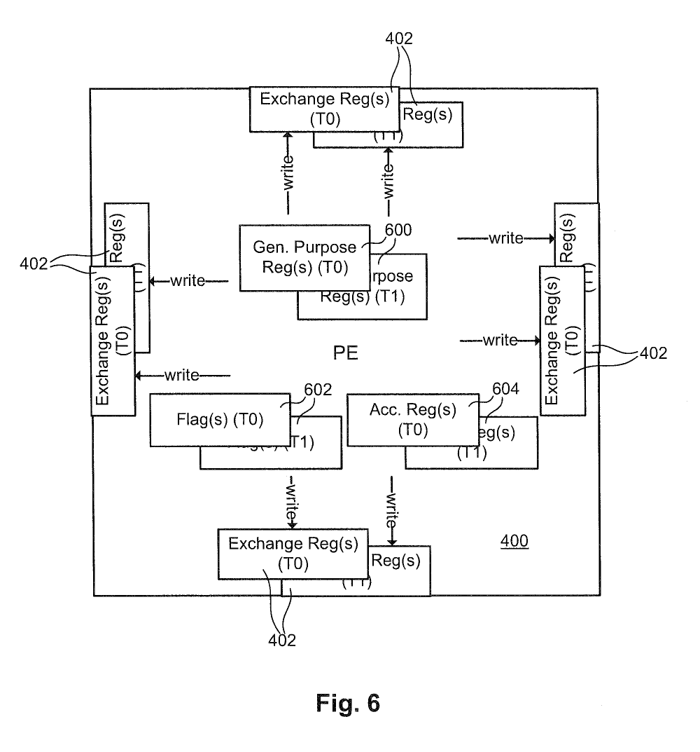

Referring to FIG. 6, each of the processing elements 400 of the VPU array 300 may include various internal general purpose registers 600, flags 602, and accumulator registers 604. Each of the processing elements 400 may also include exchange registers 402 for communicating with neighboring processing elements 400. In certain embodiments, each processing element 400 may be capable of supporting multiple interleaved threads. As a result, a set of registers and flags may be associated with each interleaved thread to store the state of the thread. In the illustrated example, the processing element 400 supports two interleaved threads (T0 and T1) and includes separate registers and flags for each. Each interleaved thread may have its own state and execute independently of the other interleaved thread. Thus, a first interleaved thread could fail or crash while the other interleaved thread continues executing. In certain embodiments, since the write path to the exchange registers 402 may have the most critical timing, these registers 402 may be physically located in the processing element 400 that performs the writing, although this is not necessary. It follows that the exchange registers 402 that the processing element 400 reads from may be located in neighboring processing elements.

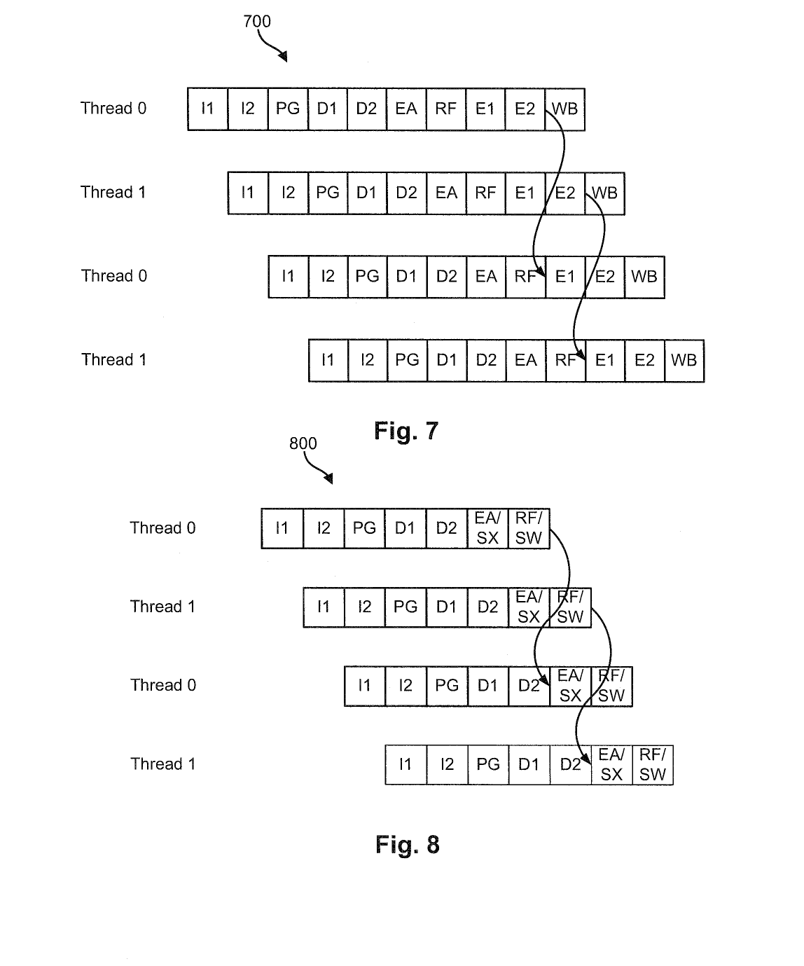

Referring to FIG. 7, as previously mentioned, a vector processor (which may include the VPC 302 and VPU array 300) may be configured to operate with a multiple-stage execution pipeline 700. Similarly, the vector processor may be configured to operate on multiple threads in an interleaved fashion. For example, as illustrated, the vector processor pipeline 700 may, in certain embodiments, be a dual-threaded ten-stage execution pipeline 700. Two threads (thread 0 and thread 1) are interleaved using instruction multi-threading (IMT) as shown in FIG. 7. The first five stages (I1-D2) may be executed in the VPC 302, the sixth stage (EA) may be executed by the AGU 310, and the last four stages (RF-WB) may be executed by each of the processing elements 400.

Instructions may be read from the cluster instruction memory 304 during the I1 stage and aligned during the I2 and PG stages. In addition to initial decoding of the instruction, control instructions may also be executed during the D1 and D2 stages. During the EA (effective address) generation stage, the AGU 310 may calculate physical addresses for accesses to the data memory 308 and also distribute address and control signals to the processing elements 400 in the array 300. The EA stage may also be used as the execution stage of the scalar ALU 306. The data memory 308 may be read during the RF stage and data that is loaded from or stored in the data memory 308 may be valid on the load and store busses during the E1 stage. The vector arithmetic logic performed by the processing elements 400 may be performed during the E1 and E2 stages and the result may be written back during the WB stage either to the processing element registers or to the data memory 308.

The interleaved multi-threading process described herein allows two separate threads to run through the same pipeline 700 in alternate cycles. The single pipeline 700 effectively executes two separate threads simultaneously so there is no perceivable loss in instruction throughput and logically it appears that there are two separate VPU arrays 300, each running at half the clock frequency. One major advantage of this implementation is that it reduces the amount of bypassing logic required in order to minimize pipeline bubbles. Bypasses may be implemented to forward results/data from the end of the E2 stage to the end of the subsequent RF stage (as indicated by the arrows). This allows the result of an arithmetic instruction to be used by the next instruction in the same thread as illustrated in FIG. 7.

The interleaved multi-threading process illustrated in FIG. 7 may be used to significantly increase the throughput of the VPU array 300. This is at least partly due to the fact that the throughput of the VPU array 300 may be limited by wiring delays or delays waiting for data to settle in registers or other memory elements. By executing the threads in an interleaved fashion, one thread may be executed while instructions or data associated with the other thread are propagating over wire or settling in registers or other memory elements. This may allow each interleaved thread to operate at some fraction of the overall clock speed of the VPU array 300. For example, using two interleaved threads, the clock speed of each thread may be 400 Mhz while the clock speed of the VPU array 300 is 800 Mhz. This technique significantly increases efficiency and uses the time associated with wiring delays or register settling of one thread to perform useful work associated with another thread.

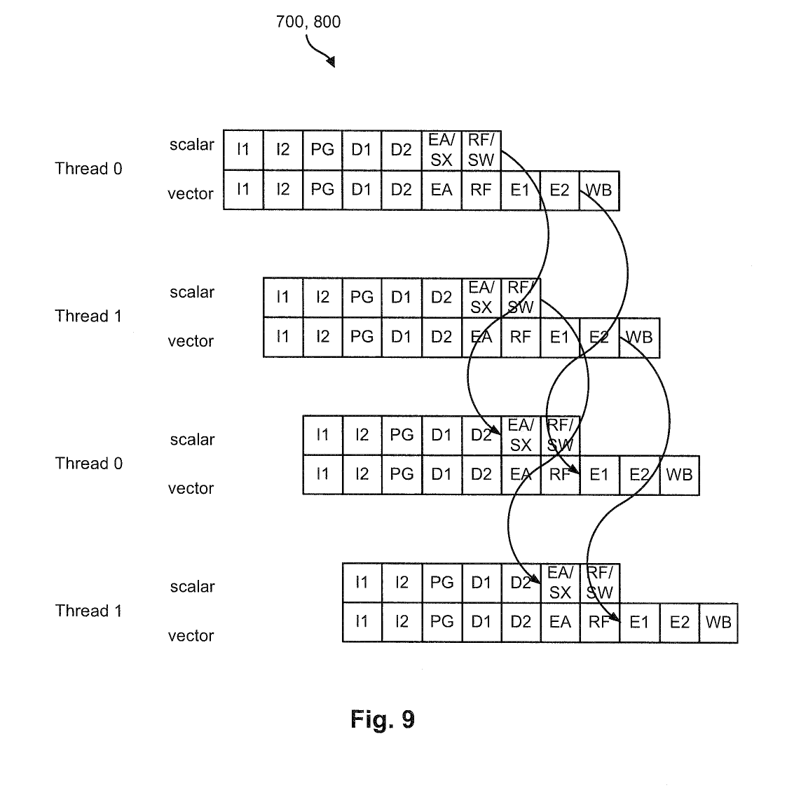

Referring to FIG. 8, similar to the vector processor pipeline 700 described in FIG. 7, a scalar ALU pipeline 800 may be used by the scalar ALU 306 when performing scalar operations. In the illustrated embodiment, the EA and RF stages for the VPU array 300 correspond to the execution (SX) and writeback (SW) stages of the scalar ALU 306. In the illustrated embodiment, the first five stages of the scalar ALU pipeline 800 are the same for the VPU array 300 and the scalar ALU 306. The execution (SX) and writeback (SW) stages are different and may be implemented as part of the scalar ALU data path. One difference between the illustrated scalar and vector pipelines 700, 800 is that the scalar pipeline 800 is three cycles shorter than the vector pipeline 700. Since two threads are interleaved, any result produced by the scalar operation is available in the next instruction cycle for the same thread regardless of whether the result is used by the scalar ALU 306 or the VPU array 300. FIG. 9 shows both the scalar and vector pipelines 700, 800 in parallel including their forwarding bypasses (as indicated by the arrows).

Referring to FIG. 10, as previously mentioned, in selected embodiments, the VPU array 300 may be configured to act in a “modified SIMD” fashion. This may enable certain processing elements to be grouped together and the groups of processing elements to handle instructions differently. To provide this functionality, in selected embodiments, the VPC 302 may contain a grouping module 1012 and a modification module 1014. In general, the grouping module 1012 may be used to assign each processing element within the VPU array 300 to one of several groups. A modification module 1014 may designate how each group of processing elements should handle different instructions.

FIG. 10 shows one example of a method for implementing the grouping module 1012 and modification module 1014. In selected embodiments, the grouping module 1012 may include a PE map 1002 to designate which group each processing element belongs to. This PE map 1002 may, in certain embodiments, be stored in a register 1000 on the VPC 302. This register 1000 may be read by each processing element so that it can determine which group it belongs to. For example, in selected embodiments, the PE map 1002 may store two bits for each processing element (e.g., 32 bits total for 16 processing elements), allowing each processing element to be assigned to one of four groups (groups 0, 1, 2, and 3). This PE map 1002 may be updated as needed by the scalar ALU 306 to change the grouping.

In selected embodiments, the modification module 1014 may include an instruction modifier 1004 to designate how each group should handle an instruction 1006. Like the PE map 1002, this instruction modifier 1004 may, in certain embodiments, be stored in a register 1016 that may be read by each processing element in the array 300. For example, consider a VPU array 300 where the PE map 1002 designates that the first two columns of processing elements belong to “group 0” and the second two columns of processing elements belong to “group 1.” An instruction modifier 1004 may designate that group 0 should handle an ADD instruction as an ADD instruction, while group 1 should handle the ADD instruction as a SUB instruction. This will allow each group to handle the ADD instruction differently. Although the ADD instruction is used in this example, this feature may be used for a host of different instructions.

In certain embodiments, the instruction modifier 1004 may also be configured to modify a source operand 1008 and/or a destination operand 1010 of an instruction 1006. For example, if an ADD instruction is designed to add the contents of a first source register (R1) to the contents of a second source register (R2) and to store the result in a third destination register (R3), the instruction modifier 1004 may be used to modify any or all of these source and/or destination operands. For example, the instruction modifier 1004 for a group may modify the above-described instruction such that a processing element will use the source operand in the register (R5) instead of R1 and will save the destination operand in the destination register (R8) instead of R3. In this way, different processing elements may use different source and/or destination operands 1008, 1010 depending on the group they belong to.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for processing data, the apparatus comprising:
an array of processing elements configured to simultaneously perform operations on a plurality of data elements using a single instruction, the array of processing elements comprising a first processing element and a second processing element adjacent to the first processing element, the first processing element configured to directly transfer data to the second processing element.

2. The apparatus of claim 1, wherein the second processing element is further configured to transfer data to the first processing element.

3. The apparatus of claim 2, further comprising a first exchange register to temporarily store data transferred from the first processing element to the second processing element.

4. The apparatus of claim 3, wherein the first processing element communicates with a write port of the first exchange register and the second processing element communicates with a read port of the first exchange register.

5. The apparatus of claim 4, further comprising a second exchange register to temporarily store data transferred from the second processing element to the first processing element.

6. The apparatus of claim 5, wherein the second processing element communicates with a write port of the second exchange register and the first processing element communicates with a read port of the second exchange register.

7. The apparatus of claim 1, wherein the array is an n×m array of processing elements.

8. The apparatus of claim 7, wherein the array is an n×n array of processing elements.

9. The apparatus of claim 7, wherein the processing elements are configured to communicate with processing elements to the north, south, east, and west of the processing elements.

10. A method for processing data, the method comprising:
providing an array of processing elements configured to simultaneously perform operations on a plurality of data elements using a single instruction, the array of processing elements comprising a first processing element and a second processing element adjacent to the first processing element; and
directly transferring data by the first processing element to the second processing element.

11. The method of claim 10, further comprising directly transferring data by the second processing element to the first processing element.

12. The method of claim 11, wherein directly transferring data by the first processing element comprises temporarily storing data in a first exchange register between the first processing element and the second processing element.

13. The method of claim 12, wherein directly transferring data by the first processing element comprises writing, by the first processing element, to a write port of the first exchange register and reading, by the second processing element, from a read port of the first exchange register.

14. The method of claim 13, wherein directly transferring data by the second processing element comprises temporarily storing data in a second exchange register between the second processing element and the first processing element.

15. The method of claim 14, wherein directly transferring data by the second processing element comprises writing, by the second processing element, to a write port of the second exchange register and reading, by the first processing element, from a read port of the second exchange register.

16. An apparatus for processing data, the apparatus comprising:
an array of processing elements configured to simultaneously perform operations on a plurality of data elements using a single instruction, each processing element configured to transfer data directly to at least one neighboring processing element within the array.

17. The apparatus of claim 16, further comprising exchange registers between neighboring processing elements to temporarily store data transferred therebetween.

18. The apparatus of claim 17, wherein the exchange registers enable unidirectional communication between neighboring processing elements.

19. The apparatus of claim 17, wherein the exchange registers enable bidirectional communication between neighboring processing elements.

20. The apparatus of claim 16, wherein the array is an n×m array of processing elements.

21. The apparatus of claim 20, wherein the array is an n×n array of processing elements.

22. The apparatus of claim 20, wherein the processing elements are configured to communicate with processing elements to the north, south, east, and west of the processing elements.
